(19) United States
(12) Patent Application Publication
(10) Pub. No.: US 2025/0238101 A1
(43) Pub. Date: Jul. 24, 2025

(54) DISPLAY DEVICE AND DRIVING METHOD OF THE SAME

(71) Applicant: LG Display Co., Ltd., Seoul (KR)

(72) Inventors: Jae Hee PARK, Paju-si (KR); Do Jin KIM, Paju-si (KR)

(73) Assignee: LG Display Co., Ltd., Seoul (KR)

(21) Appl. No.: 18/986,314

(22) Filed: Dec. 18, 2024

(30) Foreign Application Priority Data
Dec. 29, 2023 (KR) 10-2023-0197873

(51) Int. Cl. G06F 3/041; G09G 3/3266; G09G 3/3291

(52) U.S. Cl. CPC G06F 3/04186; G09G 3/3266; G09G 3/3291

(57) ABSTRACT

A display device can include a substrate, an emissive area disposed on the substrate and having a light emitting element configured to emit light, and a touch area disposed adjacent to the emissive area and configured to sense whether or not there is a touch. The display device further includes a gate line connected to the emissive area and the touch area in common.

### CROSS-REFERENCE TO RELATED APPLICATIONS

This application claims priority to Korean Patent Application No. 10-2023-0197873, filed in the Republic of Korea on Dec. 29, 2023, the entire contents of which is hereby expressly incorporated by reference as if fully set forth herein into the present application.

### BACKGROUND

### Field

The present disclosure relates to a display device and a driving method of the same.

### Discussion of the Related Art

In accordance with advances in information technology, the market for a display device which is a connection medium between a user and information is expanding. Accordingly, the use of a display device such as a light emitting display device (LED), a quantum dot display device (QDD), a liquid crystal display device (LCD), etc. is increasing.

The above-mentioned display devices include a display panel including sub-pixels, a driver configured to output a drive signal for driving of the display panel, a power supply configured to generate power to be supplied to the display panel or the driver, etc.

In such display devices, when a drive signal (for example, a scan signal, a data signal, etc.) is supplied to the sub-pixels formed at the display panel, selected ones of the sub-pixels transmit light therethrough or directly emit light and, as such, an image can be displayed. In addition, such display devices can receive an input of the user in the form of a touch based on a touch sensor, and can execute a command corresponding to the touch input.

### SUMMARY OF THE DISCLOSURE

Accordingly, the present disclosure is directed to a display device and a driving method of the same that substantially obviate one or more problems due to limitations and disadvantages of the related art.

An object of the present disclosure is to enhance production yield of a display device including a touch sensor by minimizing the number of touch lines, eliminating possibility of generation of a cross talk which can be caused by interference between a data line and a touch line based on spaced dispositions of the data line and the touch line, and enabling detection of whether or not there is a failed touch electrode and a failure generation position by itself.

Another object of the present disclosure is to reduce costs needed for implementation of a display device including a touch sensor by omitting provision of a separate inspection structure and separate inspection equipment.

Objects of the present disclosure are not limited to the above-described objects, and other objects of the present disclosure not yet described will be more clearly understood by those skilled in the art from the following detailed description.

To achieve these objects and other advantages and in accordance with the purpose of the disclosure, as embodied and broadly described herein, a display device includes a substrate, an emissive area defined on the substrate and including a light emitting element configured to emit light, a touch area disposed adjacent to the emissive area and configured to sense whether or not there is a touch, and a gate line connected to the emissive area and the touch area in common.

The gate line can be connected to a gate of a switching transistor included in the emissive area and a gate of a touch transistor included in the touch area in common.

For one frame, the gate line can first transmit a scan signal of a first pulse and can then transmit a scan signal of a second pulse after a predetermined time elapses from the transmission of the scan signal of the first pulse.

In another aspect of the present disclosure, a display device includes a display panel including a pixel including an emissive area including a light emitting element configured to emit light, and a touch area disposed adjacent to the emissive area and including a touch electrode configured to sense whether or not there is a touch, and a gate line connected to the emissive area and the touch area included in the pixel in common; a scan driver connected to the gate line; and a data driver connected to the pixel, the data driver including a first circuit configured to supply a data voltage to the emissive area, and a second circuit configured to supply a touch drive voltage to the touch area.

For one frame, the scan driver can first output a scan signal of a first pulse and can then output a scan signal of a second pulse through the gate line after a predetermined time has elapsed from the outputting of the scan signal of the first pulse.

The data driver can output a data voltage through a data line connected to the emissive area, and can output a touch drive voltage through a touch line connected to the touch area, in response to the scan signal of the first pulse. The data driver can sense a touch drive voltage charged in the touch area as a touch sensing voltage in response to the scan signal of the second pulse.

The gate line can be connected to a gate of a switching transistor included in the emissive area and a gate of a touch transistor included in the touch area in common.

The scan driver can be controlled such that the scan signal of the first pulse and the scan signal of the second pulse are sequentially applied to all gate lines of the display panel. The data driver can be controlled to sense the touch sensing voltage from all pixels of the display panel, corresponding to sequential application of the scan signals.

The emissive area can include a red sub-pixel, a green sub-pixel, a blue sub-pixel, and a white sub-pixel. The touch area can include at least one dummy touch electrode surrounding the touch electrode.

The touch transistor can be connected to the gate line at the gate thereof, while being connected to the touch line at a first electrode thereof and being connected to the touch electrode at a second electrode.

The second electrode of the touch transistor can be connected to the touch electrode through a connection electrode disposed at a layer higher or lower than the at least one dummy touch electrode.

The touch area can include a transmission area configured to transmit natural light or an object incident thereto through a front surface or a back surface of the display panel.

In another aspect of the present disclosure, there is discussed a driving method of a display device including a display panel comprising a substrate, an emissive area defined on the substrate and including a light emitting element configured to emit light, a touch area disposed adjacent to the emissive area and configured to sense whether or not there is a touch, and a gate line connected to the emissive area and the touch area in common. The driving method includes outputting a scan signal of a first pulse for one frame through the gate line, and outputting a scan signal of a second pulse for the one frame through the gate line. The scan signal of the second pulse is output after a predetermined time has elapsed from the outputting of the scan signal of the first pulse.

The display device according to aspects of the present disclosure has an effect capable of omitting a separate read-out integrated circuit (ROIC) because a touch electrode used as a touch sensor is disposed in a transmissive area, a touch line is disposed in the same direction as that of a data line while being spaced apart from the data line, and the touch electrode is driven in a scan manner. In addition, the display device according to aspects of the present disclosure can have an effect capable of minimizing the number of touch lines because touch lines are disposed in the same direction as data lines while being spaced apart from the data lines. Furthermore, the display device according to aspects of the present disclosure can have an effect capable of eliminating possibility of generation of a cross talk caused by interference between a data line and a touch line based on spaced dispositions of the data line and the touch line. In addition, the display device according to aspects of the present disclosure can detect whether or not there is failure of a touch electrode and a failure generation position by itself and, as such, can have an effect capable of enhancing production yield and omitting provision of a separate inspection structure and separate inspection equipment.

### BRIEF DESCRIPTION OF THE DRAWINGS

The accompanying drawings, which are included to provide a further understanding of the disclosure and are incorporated in and constitute a part of this application, illustrate embodiment(s) of the disclosure and along with the description serve to explain the principle of the disclosure. In the drawings:

FIG. 1 is a block diagram schematically showing a light emitting display device according to one or more embodiments of the present disclosure;

FIG. 2 is a configuration diagram schematically showing a sub-pixel shown in FIG. 1;

FIGS. 3 to 5 are block diagrams briefly explaining a configuration of a light emitting display device having a touch censor according to one or more embodiments of the present disclosure;

FIGS. 6 and 7 are sectional views briefly explaining a display panel including an emissive area, a transmissive area, and a touch sensor disposed in the transmissive area according to one or more embodiments of the present disclosure;

FIG. 8 is a diagram briefly showing configurations of sub-pixels included in a display panel according to a first embodiment of the present disclosure;

FIG. 9 is a first illustrative diagram briefly explaining a driving method of a light emitting display device including the display panel according to the first embodiment;

FIG. 10 is a second illustrative diagram briefly explaining the driving method of the light emitting display device including the display panel according to the first embodiment;

FIGS. 11 and 12 are diagrams showing touch drive voltage application and touch drive voltage sensing distinguished from each other in accordance with the first embodiment;

FIG. 13 is an illustrative waveform diagram supporting understanding of a driving method according to the first embodiment;

FIG. 14 is a diagram briefly showing configurations of sub-pixels included in a display panel according to a second embodiment of the present disclosure;

FIG. 15 is a diagram briefly explaining a driving method of a light emitting display device including the display panel according to the second embodiment;

FIG. 16 is a diagram concretely explaining the driving method of the light emitting display device including the display panel according to the second embodiment;

FIGS. 17 to 22 are illustrative diagrams showing operations and waveforms of a sub-pixel in sequential steps of a driving method according to the second embodiment in order to support understanding of the driving method of the second embodiment;

FIG. 23 is a plan view showing a first pixel having a first emissive area and a first touch area in accordance with a third embodiment of the present disclosure;

FIG. 24 is a cross-sectional view taken along line A1-A2 of FIG. 23;

FIG. 25 is a cross-sectional view taken along line B1-B2 of FIG. 23;

FIG. 26 is a cross-sectional view taken along line C1-C2 of FIG. 23; and

FIG. 27 is a diagram explaining additional characteristics of a light emitting display device including a display panel according to the third embodiment.

### DETAILED DESCRIPTION OF THE EMBODIMENTS

Features of various embodiments of the present disclosure can be partially or entirely coupled to or combined with each other and can be operated, linked, or driven together in various ways. Embodiments of the present disclosure can be carried out independently from each other, or can be carried out together in co-dependent or related relationship.

Further, the term “can” encompasses all the meanings and coverages of the term “may.” The term “disclosure” is interchangeably used with, or encompasses all the meanings and coverages of, the term “invention.”

All the components of each display device or apparatus according to all embodiments of the present disclosure are operatively coupled and configured.

A display device according to aspects of the present disclosure can be embodied as a television, an image player, a personal computer (PC), a home theater, a car electric device, a smartphone, etc., without being limited thereto. The display device according to the present disclosure can be embodied as a light emitting display device (LED), a Micro-LED display device, a quantum dot display device (QDD), a liquid crystal display device (LCD), etc. For convenience of description, however, the following description will be given in conjunction with an example in which the display device according to the present disclosure is a light emitting display device configured to directly emit light based on an inorganic light emitting diode or an organic light emitting diode.

In addition, thin film transistors, which will be described hereinafter, can be implemented as an n-type thin film transistor, a p-type thin film transistor, or a form in which both an n-type and a p-type are present. Such a thin film transistor is a three-electrode element including a gate, a source, and drain. The source is an electrode configured to supply carriers to the thin film transistor. In the thin film transistor, carriers flow from the source. The drain is an electrode configured to allow carriers in the thin film transistor to be discharged to an outside of the thin film transistor. For example, flow of carriers in the thin film transistor proceeds from the source to the drain.

In a p-type thin film transistor, carriers are holes and, as such, a source voltage is higher than a drain voltage in order to enable holes to flow from the source to the drain. In the p-type thin film transistor, current flows from the source to the drain because holes flow from the source to the drain. Conversely, in an n-type thin film transistor, carriers are electrons and, as such, a source voltage is lower than a drain voltage in order to enable electrons to flow from the source to the drain. The direction of current in the n-type thin film transistor proceeds from the drain to the source because electrons flow from the source to the drain. However, the source and the drain of a thin film transistor can be interchanged in accordance with a voltage applied to the thin film transistor. In this regard, in the following description, one of the source and the drain will be referred to as a “first electrode”, and the other of the source and the drain will be referred to as a “second electrode”.

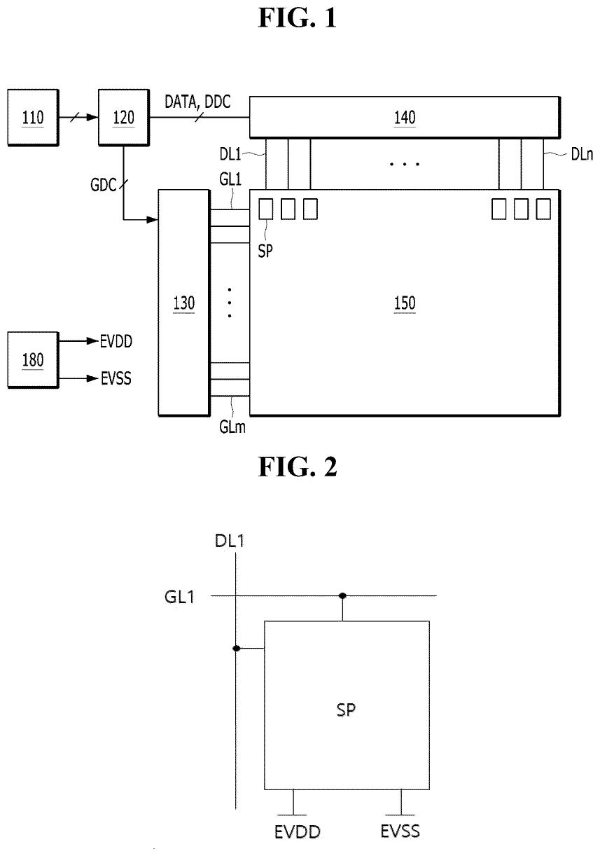

FIG. 1 is a block diagram schematically showing a light emitting display device according to one or more embodiments of the present disclosure. FIG. 2 is a configuration diagram schematically showing a sub-pixel shown in FIG. 1.

As shown in FIGS. 1 and 2, the light emitting display device can include an image supplier 110, a timing controller 120, a scan driver 130, a data driver 140, a display panel 150, a power supply 180, etc.

The image supplier 110 (a set or a host system) can output various drive signals as well as an image data signal supplied from an exterior thereof or an image data signal stored in an internal memory. The image supplier 110 can supply the data signal and the various drive signals to the timing controller 120.

The timing controller 120 can output a gate timing control signal GDC for control of operation timing of the scan driver 130, a data timing control signal DDC for control of operation timing of the data driver 140, various synchronization signals (a vertical synchronization signal Vsync and a horizontal synchronization signal Hsync), etc. The timing controller 120 can supply, to the data driver 140, a data signal DATA supplied from the image supplier 110, together with the data timing control signal DDC. The timing controller 120 can be formed in the form of an integrated circuit (IC) and, as such, can be mounted on a printed circuit board, without being limited thereto.

The scan driver 130 can output a scan signal (or a gate signal) in response to the gate timing control signal GDC, etc. supplied from the timing controller 120. The scan driver 130 can supply a scan signal (or a gate signal) to sub-pixels included in the display panel 150 via gate lines GL1 to GLm. The scan driver 130 can be formed in the form of an IC or can be directly formed on the display panel 150 in the form of a gate-in-panel structure, without being limited thereto. As an example, the scan driver 130 may be connected to the display panel 150 using a tape automated bonding (TAB) method, or may be connected to the bonding pad of the display panel 150 using a chip-on-glass (COG) or chip-on-panel (COP) method, or may be implemented using a chip-on-film (COF) method and connected to the display panel 150, without being limited thereto.

The data driver 140 can sample and latch the data signal DATA in response to the data timing control signal DDC, etc. supplied from the timing controller 120, can convert a data signal having a digital form into a data voltage having an analog form, and can then output the resultant data voltage. The data driver 140 can supply the data voltage to the sub-pixels included in the display panel 150 via data lines DL1 to DLn. The data driver 140 can be formed in the form of an IC and, as such, can be mounted on the display panel 150 or a printed circuit board, without being limited thereto.

The power supply 180 can generate first power of a high level and second power of a low level based on an external input voltage supplied from an exterior thereof, can output the first power through a first power line EVDD, and can output the second power through a second power line EVSS. The power supply 180 can generate and output not only the first power and the second power, but also a voltage required for driving of the scan driver 130, a voltage required for driving of the data driver 140, etc.

The display panel 150 can display an image, corresponding to the drive signal including the scan signal (or the gate signal) and the data voltage, the first power, the second power, etc. The sub-pixels of the display panel 150 can directly emit light. The display panel 150 can be manufactured based on a substrate or a film having stiffness or ductility, such as glass, silicon, polyimide, or the like. In the display panel 150, one pixel can be configured based on a red sub-pixel, a green sub-pixel, and a blue sub-pixel, or one pixel can be configured based on a red sub-pixel, a green sub-pixel, a blue sub-pixel, and a white sub-pixel. Embodiments are not limited thereto. As an example, sub pixels of other colors such as cyan, magenta, or yellow, etc. may be alternatively or additionally included.

For example, one sub-pixel SP can include a pixel circuit connected to the first data line DL1, the first gate line GL1, the first power line EVDD, and the second power line EVSS. The pixel circuit can include a switching transistor, a driving transistor, a capacitor, an organic light emitting diode, etc., without being limited thereto.

The sub-pixel SP used in the light emitting display device directly emits light and, as such, the circuit configuration thereof is complex. In addition, a compensation circuit configured to compensate for degradation of not only the organic light emitting diode configured to emit light, but also the driving transistor configured to supply a drive current required for driving of the organic light emitting diode, etc. also has various configurations. Accordingly, it is noted that, in FIG. 2, the sub-pixel SP is simply shown in the form of a block.

Meanwhile, heretofore, the timing controller 120, the scan driver 130, the data driver 140, etc. have been described as individual configurations, respectively. However, one or more of the timing controller 120, the scan driver 130, and the data driver 140 can be integrated in one IC in accordance with an implementation method of the light emitting display device.

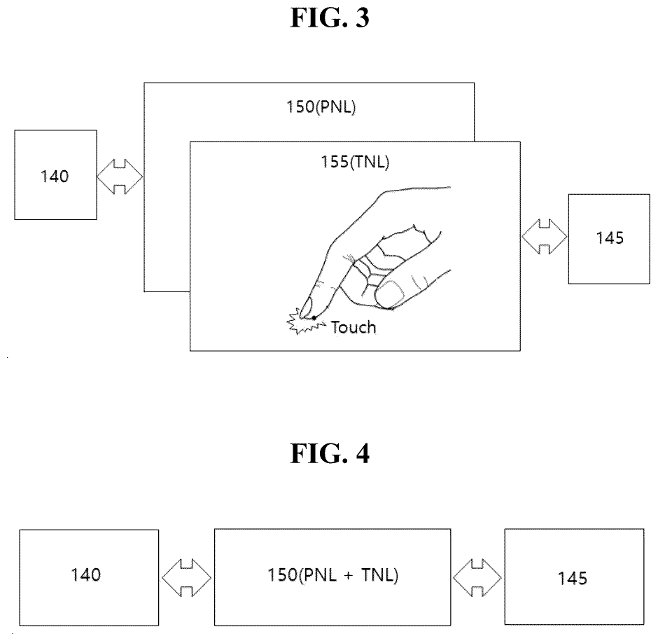

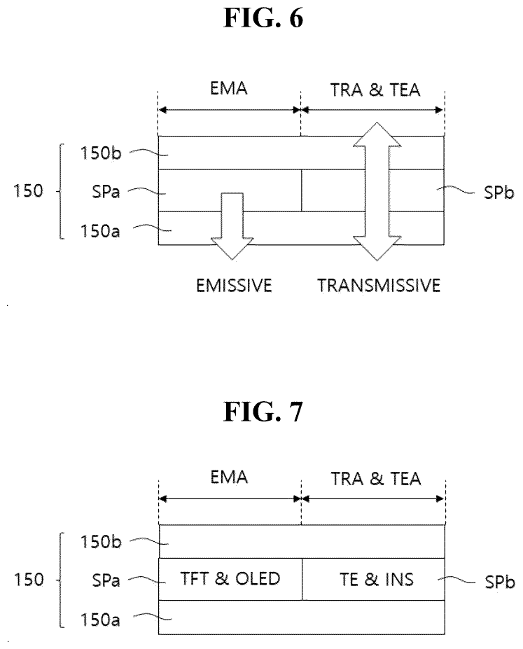

FIGS. 3 to 5 are block diagrams briefly explaining a configuration of a light emitting display device having a touch sensor according to one or more embodiments of the present disclosure. FIGS. 6 and 7 are sectional views briefly explaining a display panel including an emissive area, a transmissive area, and a touch sensor disposed in the transmissive area according to one or more embodiments of the present disclosure.

As shown in FIGS. 3 to 5, a display panel (PNL) 150 configured to display an image while being included in the light emitting display device can have a touch sensor (TNL) 155 configured to receive an input of the user in a touch manner. The touch sensor 155 can include touch electrodes configured to detect whether or not there is a touch on the display panel 150, touch position information, etc.

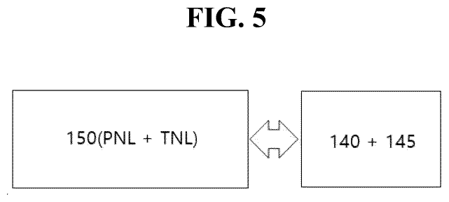

The display panel 150 can be driven by a data driver 140, and the touch sensor 155 can be driven by a touch driver 145. The display panel 150 and the touch sensor 155 can be formed through separate configurations distinguished from each other, respectively, as shown in FIG. 3, or can be integrated in the form of one panel, as shown in FIGS. 4 and 5.

In the case in which the display panel 150 and the touch sensor 155 are integrated in the form of one panel (PNL+TNL), the data driver 140 and the touch driver 145 can be provided to be independently present, respectively, as shown in FIG. 4, or can be provided such that the touch driver 145 is internally included in the data driver 140, as shown in FIG. 5.

As shown in FIG. 6, the display panel 150 can include a first substrate 150a, a second substrate 150b, and a first pixel area Spa and a second pixel area SPb interposed between the first substrate 150a and the second substrate 150b. The first pixel area Spa can be defined as an emissive area EMA, and the second pixel area SPb can be defined as a transmissive area TRA. Embodiments are not limited thereto. As an example, the display panel 150 may not include a transmissive area TRA.

The emissive area EMA is an area configured to emit light based on a sub-pixel (sub-pixels). The transmissive area TRA is an area configured to transmit light (natural light) incident through a front surface or a back surface of the display panel 150 therethrough.

The second pixel area SPb may not only be defined as the transmissive area TRA, but also can be defined as a touch area TEA. The touch area TEA is an area configured to receive an input of the user in a touch manner. For example, the second pixel area SPb can be defined as a transmissive and touch area TRA & TEA having two functions (an area having both touch sensing and transmission of natural light functions). Embodiments are not limited thereto. As an example, the second pixel area SPb may be defined as the transmissive area TRA without a touch sensing function. As an example, the first pixel area Spa may not only be defined as the emissive area EMA but also may be defined as a touch area TEA, without being limited thereto, or may be defined as the emissive area EMA without a touch sensing function. Alternatively, the second pixel area SPb may be defined as a touch area TEA without a transmission of natural light function.

As shown in FIG. 7, the first pixel area Spa defined as the emissive area EMA can include an organic light emitting diode OLED configured to emit light, a transistor TFT configured to drive the organic light emitting diode OLED, etc. The second pixel area SPb defined as the transmissive and touch area TRA & TEA can include a touch electrode TE configured to receive an input in a touch manner, and an insulating layer INS configured to insulate the touch electrode TE, without being limited thereto.

Of course, it is noted that the structure shown in FIGS. 6 and 7 and described with reference to FIGS. 6 and 7 is given for understanding of embodiments which will be described hereinafter. In addition, for convenience of description, it is noted that the transmissive and touch area TRA & TEA will be simply refer to as the touch area TEA.

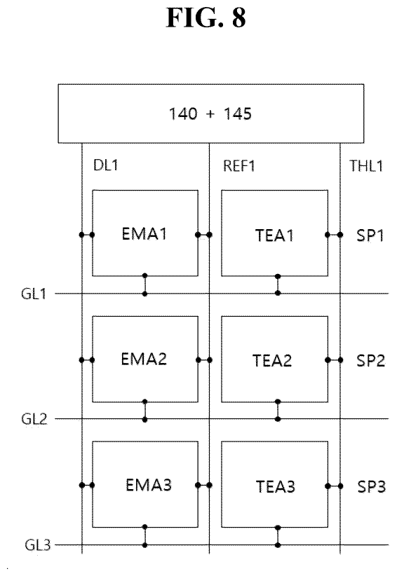

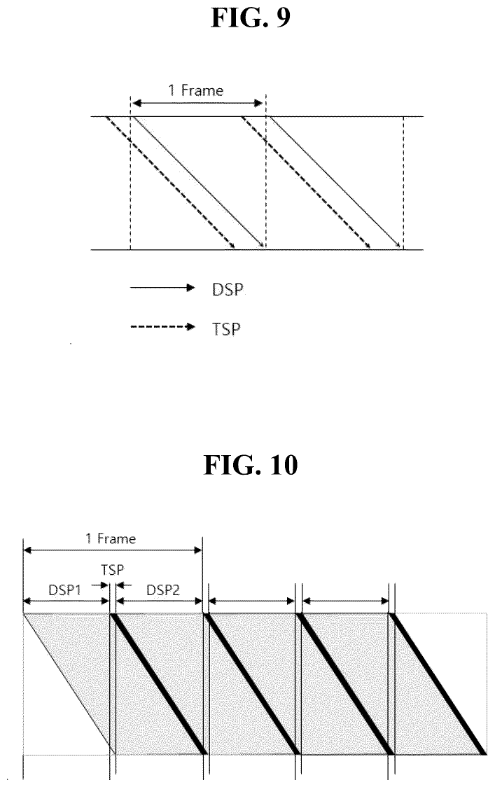

FIG. 8 is a diagram briefly showing configurations of sub-pixels included in a display panel according to a first embodiment of the present disclosure. FIG. 9 is a first illustrative diagram briefly explaining a driving method of a light emitting display device including the display panel according to the first embodiment. FIG. 10 is a second illustrative diagram briefly explaining the driving method of the light emitting display device including the display panel according to the first embodiment.

As shown in FIG. 8, in accordance with the first embodiment, the display panel can have a sub-pixel disposition structure including a first sub-pixel SP1, a second sub-pixel SP2, a third sub-pixel SP3, etc. Although an example in which the first sub-pixel SP1, the second sub-pixel SP2, and the third sub-pixel SP3 are disposed in a vertical direction are shown and described, this is only illustrative. As an example, the first sub-pixel SP1, the second sub-pixel SP2, and the third sub-pixel SP3 may be disposed in a horizontal direction, or a direction other than the vertical direction and the horizontal direction, or may be disposed in different lines.

The first sub-pixel SP1 can include a first emissive area EMA1 and a first touch area TEA1. The first emissive area EMA1 can be connected to a first data line DL1, a first reference line REF1, and a first gate line GL1, whereas the first touch area TEA1 can be connected to a first touch line THL1 and the first gate line GL1. The first sub-pixel SP1 can operate in response to a first scan signal applied thereto through the first gate line GL1, and can perform a light emitting operation and a touch sensing operation based on elements included in the first emissive area EMA1 and the first touch area TEA1.

The second sub-pixel SP2 can include a second emissive area EMA2 and a second touch area TEA2. The second emissive area EMA2 can be connected to the first data line DL1, the first reference line REF1, and a second gate line GL2, whereas the second touch area TEA2 can be connected to the first touch line THL1 and the second gate line GL2. The second sub-pixel SP2 can operate in response to a second scan signal applied thereto through the second gate line GL2, and can perform a light emitting operation and a touch sensing operation based on elements included in the second emissive area EMA2 and the second touch area TEA2.

The third sub-pixel SP3 can include a third emissive area EMA3 and a third touch area TEA3. The third emissive area EMA3 can be connected to the first data line DL1, the first reference line REF1, and a third gate line GL3, whereas the third touch area TEA3 can be connected to the first touch line THL1 and the third gate line GL3. The third sub-pixel SP3 can operate in response to a third scan signal applied thereto through the third gate line GL3, and can perform a light emitting operation and a touch sensing operation based on elements included in the third emissive area EMA3 and the third touch area TEA3.

As can be seen from the first sub-pixel SP1, the element included in the first emissive area EMA1 and the element included in the first touch area TEA1 can be connected to one gate line GL1 in common. This configuration is also applied to the second sub-pixel SP2 and the third sub-pixel SP3 in the same manner. Embodiments are not limited thereto. As an example, the element included in the emissive area and the element included in the touch area may be connected to different gate lines. As an example, the element included in the emissive area and the element included in the touch area may be operated simultaneously or may be operated independently.

Meanwhile, it is noted that an example in which the first line DL1, the first reference line REF1, and the first touch line THL1 are connected to an integrated driver 140+145 is shown in FIG. 8 in accordance with an example in which the touch driver 145 is internally included in the data driver 140. The integrated driver 140+145 can output a touch drive voltage as well as a data voltage, and can sense a touch drive voltage output for discrimination of whether or not touch has been generated. Embodiments are not limited thereto. As an example, the touch driver 145 and the data driver 140 may be separated from each other.

As shown in FIG. 9, the light emitting display device of the first embodiment can have both a display driving period DSP and a touch driving period TSP for one frame 1Frame as the sub-pixels included in the display panel are configured as shown in FIG. 8. For example, for one frame 1Frame, the display driving period DSP can be first executed, and the touch driving period TSP can be subsequently executed before the display driving period DSP ends, or, the touch driving period TSP may be first executed, and the display driving period DSP may be subsequently executed before the touch driving period TSP ends. For example, in the light emitting display device of the first embodiment, the display driving period DSP and the touch driving period TSP can be executed while partially overlapping each other.

As the touch driving period TSP is included in one frame 1Frame, as shown in FIG. 10, the display driving period DSP can be divided into a first display driving period DSP1 and a second display driving period DSP2.

Meanwhile, although an example in which the first display driving period DSP1 and the second display driving period DSP2 are divided at the same ratio is shown in FIG. 10, the division ratio of the first display driving period DSP1 and the second display driving period DSP2 can be varied in accordance with a time when the touch driving period TSP starts and, as such, the present disclosure is not limited thereto. As an example, the first display driving period DSP1 may be longer than, equal to or shorter than the second display driving period DSP2.

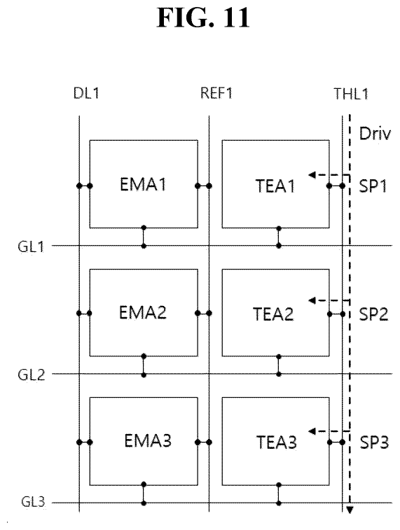

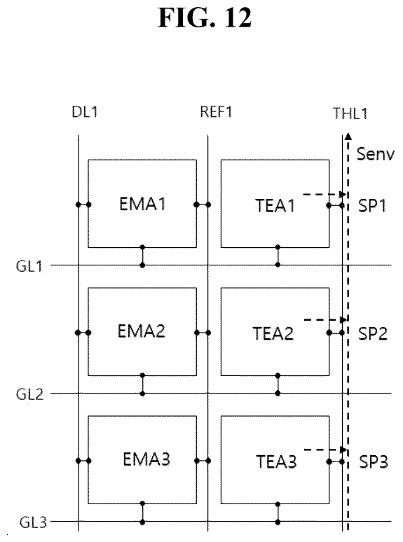

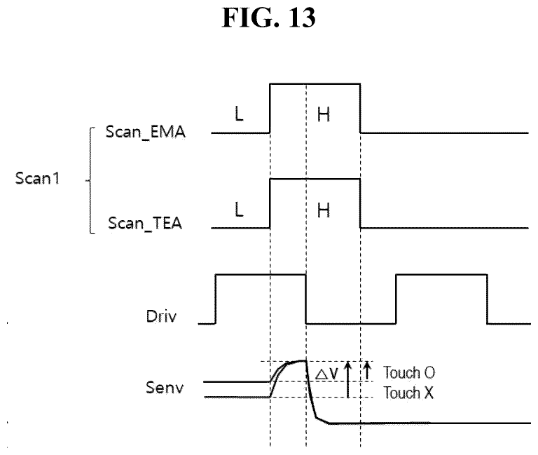

FIGS. 11 and 12 are diagrams showing touch drive voltage application and touch drive voltage sensing distinguished from each other in accordance with the first embodiment. FIG. 13 is an illustrative waveform diagram supporting understanding of a driving method according to the first embodiment.

As shown in FIG. 11, when, for a first time, a first scan signal is applied through the first gate line GL1 and a touch drive voltage Driv is applied through the first touch line THL1, the element included in the first touch area TEA1 of the first sub-pixel SP1 can have a voltage-charged state based on the touch drive voltage Driv.

When, for a second time, a second scan signal is applied through the second gate line GL2 and the touch drive voltage Driv is applied through the first touch line THL1, the element included in the second touch area TEA2 of the second sub-pixel SP2 can have a voltage-charged state based on the touch drive voltage Driv.

When, for a third time, a third scan signal is applied through the third gate line GL3 and the touch drive voltage Driv is applied through the first touch line THL1, the element included in the third touch area TEA3 of the third sub-pixel SP3 can have a voltage-charged state based on the touch drive voltage Driv.

When the first scan signal is applied through the first gate line GL1 for an N+1-th time, the voltage charged in the element included in the first touch area TEA1 of the first sub-pixel SP1 can become a touch sensing voltage Senv sensed through the first touch line THL1, as shown in FIG. 12.

When the second scan signal is applied through the second gate line GL2 for an N+2-th time, the voltage charged in the element included in the second touch area TEA2 of the second sub-pixel SP2 can become a touch sensing voltage Senv sensed through the first touch line THL1.

When the third scan signal is applied through the third gate line GL3 for an N+3-th time, the voltage charged in the element included in the third touch area TEA3 of the third sub-pixel SP3 can become a touch sensing voltage Senv sensed through the first touch line THL1.

Hereinafter, a touch sensing procedure for the first sub-pixel SP1 will be described with reference to FIGS. 12 and 13.

As shown in FIGS. 12 and 13, when a first scan signal Scan1 of a high voltage H is applied through the first gate line GL1, the first emissive area EMA1 and the first touch area TEA1 of the first sub-pixel SP1 can simultaneously become an active state. Here, “Scan_EMA” means the first scan signal Scan1 applied to the first emissive area EMA1, and “Scan_TEA” means the first scan signal Scan1 applied to the first touch area TEA1.

The element included in the first emissive area EMA1 can become an active state in order to charge a data voltage applied thereto through the first data line DL1, and the element included in the first tough area TEA1 can become an active state in order to charge a touch drive voltage Drive applied thereto through the first touch line THL1. This is because the elements respectively included in the first emissive area EMA1 and the first touch area TEA1 of the first sub-pixel SP1 share the first gate line GL1 with each other.

Meanwhile, since the element included in the first touch area TEA1 is in a voltage-charged state based on the touch drive voltage Driv, the touch sensing voltage Senv sensed through the first touch line THL1 can be varied in accordance with whether or not the first touch area TEA1 is touched by the user (a voltage variation of the touch electrode caused by a coupling difference according to whether or not there is a touch by the user in a scan-off state).

For example, when the first touch area TEA1 is touched by the user, the level of the touch sensing voltage Senv can be increased by AV (because a finger touch voltage component is added to the touch drive voltage Driv). However, when there is no touch of the first touch area TEA1 by the user, the level of the sensing voltage Senv can be still maintained at the voltage level of the charged state by the touch drive voltage Driv.

Accordingly, the touch driver can determine that touch has been generated (Touch O) or touch has not been generated (Touch X), based on a variation in the touch sensing voltage Senv sensed through the first touch line THL1.

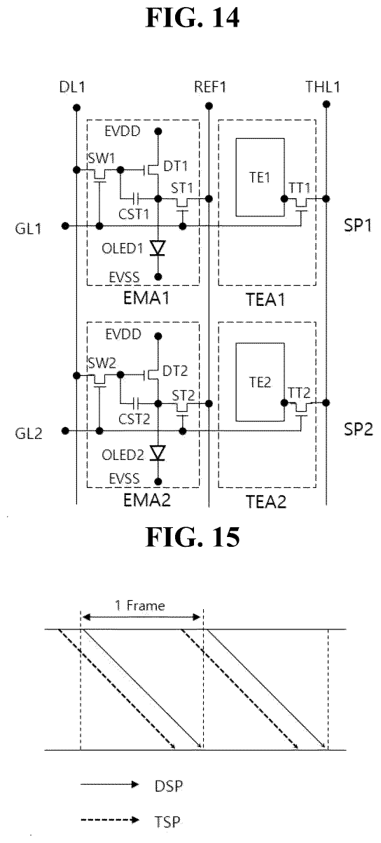

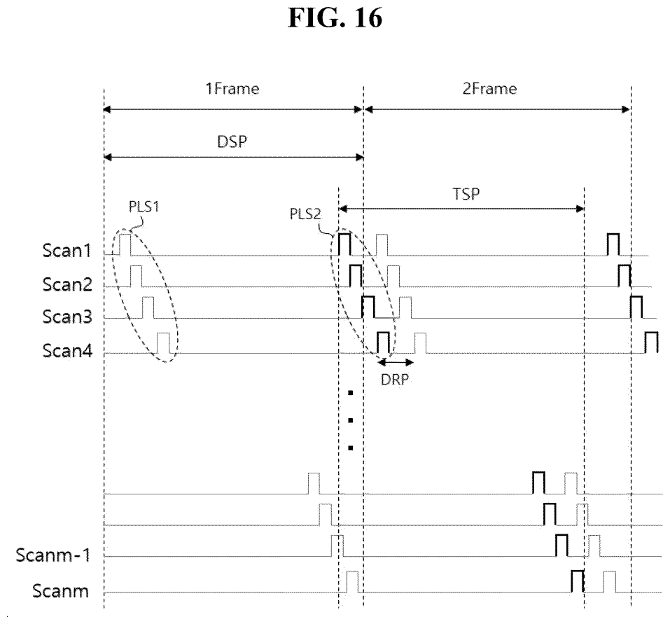

FIG. 14 is a diagram briefly showing configurations of sub-pixels included in a display panel according to a second embodiment of the present disclosure. FIG. 15 is a diagram briefly explaining a driving method of a light emitting display device including the display panel according to the second embodiment. FIG. 16 is a diagram concretely explaining the driving method of the light emitting display device including the display panel according to the second embodiment.

As shown in FIG. 14, in accordance with the second embodiment, the display panel can have a sub-pixel disposition structure including a first sub-pixel SP1, a second sub-pixel SP2, etc. Although an example in which the first sub-pixel SP1 and the second sub-pixel SP2 are disposed in a vertical direction are shown and described, this is only illustrative.

The first sub-pixel SP1 can include a first emissive area EMA1 and a first touch area TEA1. The first emissive area EMA1 can be connected to a first data line DL1, a first reference line REF1, and a first gate line GL1, whereas the first touch area TEA1 can be connected to a first touch line THL1 and the first gate line GL1.

The first emissive area EMA1 can include a first switching transistor SW1, a first capacitor CST1, a first driving transistor DT1, a first sensing transistor ST1, and a first organic light emitting diode OLED1. The first switching transistor SW1 can operate such that a data voltage applied thereto through the first data line DL1 is charged in the first capacitor CST1. The first capacitor CST1 can operate to charge or discharge a data voltage required for operation of the first driving transistor DT1. The first driving transistor DT1 can operate to generate a drive current required for operation of the first organic light emitting diode OLED1. The first sensing transistor ST1 can operate to sense a current or voltage of the first driving transistor DT1 or the first organic light emitting diode OLED1 in order to compensate for degradation of the first driving transistor DT1 or the first organic light emitting diode OLED1.

The first switching transistor SW1 can be connected to the first gate line GL1 at a gate thereof while being connected to the first data line DL1 at a first electrode thereof and connected to a first electrode of the first capacitor CST1 and a gate of the first driving transistor DT1 at a second electrode thereof. The first capacitor CST1 can be connected, at the first electrode thereof, to the second electrode of the first switching transistor SW1 and the gate of the first driving transistor DT1 while being connected, at a second electrode thereof, to the second electrode of the first driving transistor DT1, a second electrode of the first sensing transistor ST1 and an anode of the first organic light emitting diode OLED1. The first driving transistor DT1 is connected, at the gate thereof, to the second electrode of the first switching transistor SW1 and the first electrode of the first capacitor CST1 while being connected, at a first electrode thereof, to a first power line EVDD and connected, at the second electrode thereof, to the second electrode of the first capacitor CST1, the second electrode of the first sensing transistor ST1, and the anode of the first organic light emitting diode OLED1. The first organic light emitting diode OLED1 is connected, at the anode thereof, to the second electrode of the first capacitor CST1, the second electrode of the first driving transistor DT1, and the second electrode of the first sensing transistor ST1 while being connected, at a cathode thereof, to a second power line EVSS. Embodiments are not limited thereto. As an example, one or more transistors and/or capacitors may be further included. In addition, at least one of the above-mentioned components (e.g., the first sensing transistor ST1) may be omitted depending on the design.

The first touch area TEA1 can include a first touch transistor TT1 and a first touch electrode TE1. The first touch transistor TT1 can function to charge, in the first touch electrode TE1, a touch drive voltage applied thereto through the first touch line THL1 or to operate to sense, through the first touch line THL1, the touch drive voltage charged in the first touch electrode TE1. The first touch transistor TT1 is connected to the first gate line GL1 at a gate thereof while being connected to the first touch line THL1 at a first electrode thereof and connected to the first touch electrode TEL1 at a second electrode thereof. Embodiments are not limited thereto. As an example, one or more transistors and/or capacitors may be further included.

The first sub-pixel SP1 can operate in response to a first scan signal applied thereto through the first gate line GL1, and can perform a touch sensing operation as well as an operation for emitting light based on the elements included in the first emissive area EMA1 and the first touch area TEA1.

The second sub-pixel SP2 can include a second emissive area EMA2 and a second touch area TEA2. The second emissive area EMA2 can be connected to the first data line DL1, the first reference line REF1, and a second gate line GL2, whereas the second touch area TEA2 can be connected to the first touch line THL1 and the second gate line GL2.

The second emissive area EMA2 can include a second switching transistor SW2, a second capacitor CST2, a second driving transistor DT2, a second sensing transistor ST2, and a second organic light emitting diode OLED2. The second touch area TEA2 can include a second touch transistor TT2 and a second touch electrode TE2. Connection relations of the elements included in the second emissive area EMA2 and the second touch area TEA2 of the second sub-pixel SP2 refer to connection relations of the elements included in the first emissive area EMA1 and the first touch area TEA1 of the first sub-pixel SP1.

The second sub-pixel SP2 can operate in response to a second scan signal applied thereto through the second gate line GL2, and can perform a touch sensing operation as well as an operation for emitting light based on the elements included in the second emissive area EMA2 and the second touch area TEA2.

As shown in FIG. 15, the light emitting display device of the second embodiment can have both a display driving period DSP and a touch driving period TSP for one frame 1Frame as the sub-pixels included in the display panel are configured as shown in FIG. 14. For example, for one frame 1Frame, the display driving period DSP can be first executed, and the touch driving period TSP can be subsequently executed before the display driving period DSP ends. For example, in the light emitting display device of the second embodiment, the display driving period DSP and the touch driving period TSP can be executed while partially overlapping each other. This can be understood by referring to FIG. 16.

As shown in FIG. 16, a first scan signal Scan1 (a scan signal of a first gate line) to an m-th scan signal Scanm (a scan signal of a final gate line) can be sequentially generated in the display panel for one frame 1Frame, For example, a first frame. This can be similarly carried out for a second frame 2Frame next to the first frame 1Frame.

As can be seen from a second pulse PLS2 having a high voltage while having a generation time difference from a first pulse PLS1 having a high voltage, two scan signals can be sequentially generated in the display panel for one frame 1Frame while having a predetermined generation time difference therebetween. As an example, the second pulse PLS2 may have the same level as the first pulse PLS1, or may have a different level from the first pulse PLS1. As an example, the second pulse PLS2 may have the same pulse width as the first pulse PLS1, or may have a different pulse width from the first pulse PLS1. As an example, the predetermined generation time difference may be constant or may be varied from the first scan signal Scan1 to the m-th scan signal Scanm.

A data voltage and a touch drive voltage can be applied for a first time in which the scan signal of the first pulse PLS1 having a high voltage can be applied. In addition, a touch drive voltage can be sensed for an N+1-th time in which the scan signal of the second pulse PLS2 having a high voltage is generated. Accordingly, the period in which the first pulse PLS1 is generated at each of the first scan signal Scan1 to the m—the scan signal Scanm can be defined as a display driving period DSP, whereas the period in which the second pulse PLS2 is generated at each of the first scan signal Scan1 to the m—the scan signal Scanm can be defined as a touch driving period TSP.

Although an example in which the scan signal of the second pulse PLS2 for definition of the touch driving period TSP is generated in a second half of one frame 1Frame has been illustrated in the second embodiment of FIG. 16, it is noted that the present disclosure is not limited thereto. As an example, the scan signal of the second pulse PLS2 may be generated in a first half of one frame 1Frame. As an example, the second pulse PLS2 of one scan signal may partially or fully overlap with a first pulse PLS1 of another scan signal, or may not overlap any first pulse PLS1 of any scan signal.

In addition, each of the sub-pixels according to the second embodiment includes the sensing transistors ST1 and ST2 and, as such, a sensing operation for compensation for degradation of elements (mobility compensation or threshold voltage compensation) can be performed in accordance with operations of the sensing transistors ST1 and ST2. Although it is illustrated that the gates of the sensing transistors ST1 and ST2 are also connected to the scan line, embodiments are not limited thereto. As an example, the gates of the sensing transistors ST1 and ST2 may be connected to a separate scan line.

The sensing operation may not be performed for all sub-pixels and, as such, a luminance difference between a sensing line and a non-sensing line can be visible. To this end, a recovery operation DRP for recovering a data voltage can be performed until the scan signal of the first pulse PLS1 is generated after generation of the scan signal of the second pulse PLS2, in order to reduce or prevent the luminance difference between the sensing line and the non-sensing line from being visible.

The recovery operation DRP is a data voltage recovery operation in which a recovery data voltage is applied to a sensing sub-pixel selected by the sensing operation. The recovery data voltage can be selected by a voltage having a voltage value equal to or higher than that of a previously-applied data voltage, without being limited thereto.

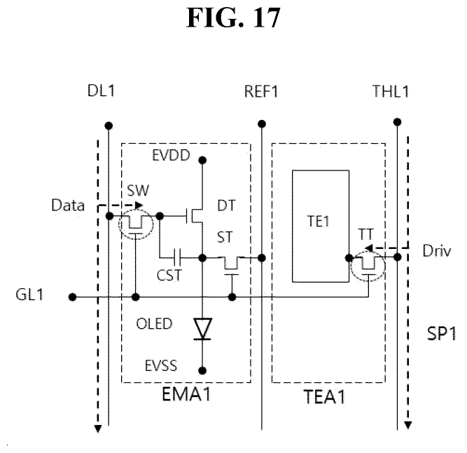

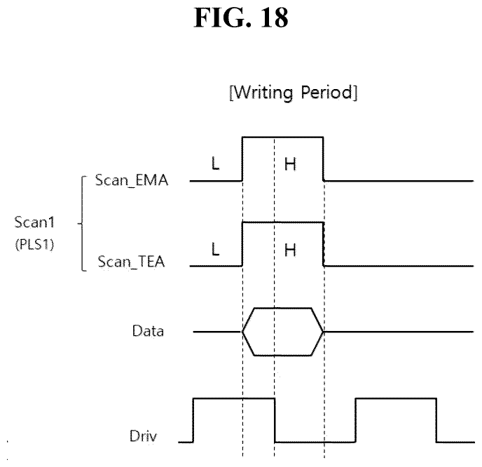

FIGS. 17 to 22 are illustrative diagrams showing operations and waveforms of a sub-pixel in sequential steps of a driving method according to the second embodiment in order to support understanding of the driving method of the second embodiment. In FIGS. 18, 20, and 22, “Scan_EMA” means a first scan signal Scan1 applied to the first emissive area EMA1, and “Scan_TEA” means a first scan signal Scan1 applied to the first touch area TEA1.

As shown in FIGS. 17 and 18, a period in which a first scan signal Scan1 of a first pulse PLS1 corresponding to a high voltage H is applied can be defined as a writing period in which a data voltage Data and a touch drive voltage Driv are written.

For the writing period, a switching transistor SW of the first emissive area EMA1 and a touch transistor TT of the first touch area TEA1 can be simultaneously turned on in response to the first scan signal Scan1 of the first pulse PLS1 corresponding to the high voltage H. The switching transistor SW can transmit, to a capacitor CST, the data voltage Data applied thereto through the first data line DL1. The touch transistor TT can transmit, to the touch electrode TE1, the touch drive voltage Driv applied thereto through the first touch line THL1. Accordingly, the data voltage Data is charged in the capacitor CST, and the touch driving voltage Driv can be charged in the touch electrode TE1.

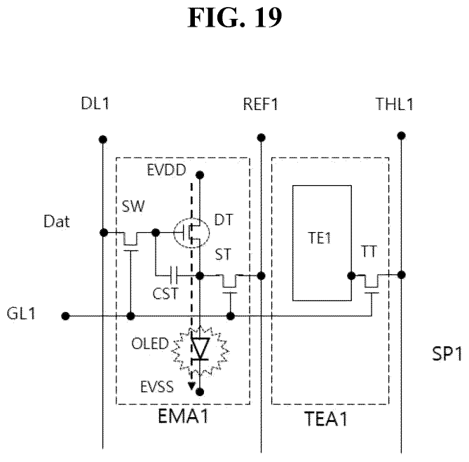

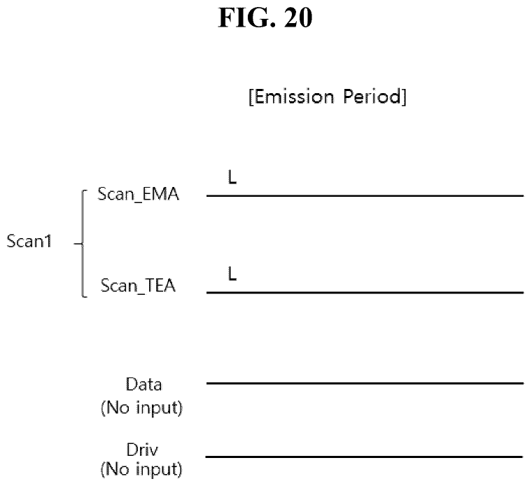

As shown in FIGS. 19 and 20, a period in which a first scan signal Scan1 of a first pulse PLS1 corresponding to a low voltage L is applied can be defined as an emission period. For the emission period, at least one of the first data line DL1 or the first touch line THL1 can be in a voltage non-transmission state.

For the emission period, the driving transistor DT of the first emissive area EMA1 can operate based on a data voltage transmitted thereto from the capacitor CST and, as such, can generate a drive current. The organic light emitting diode OLED can emit light based on the drive current generated from the drive transistor DT. Meanwhile, for the emission period, the first touch area TEA1 maintains the touch drive voltage Driv. Accordingly, although this period is defined as an emission period in association with the first emissive area EMA1, this period can be defined as a holding period in association with the first touch area TEA1.

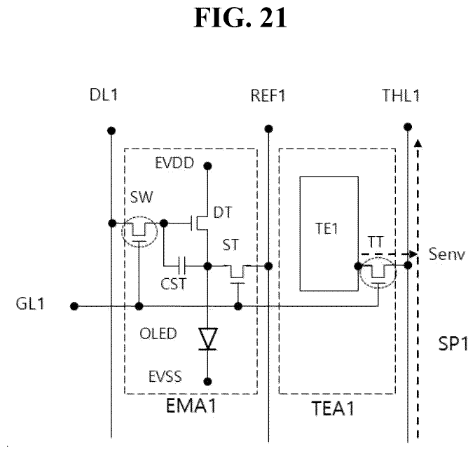

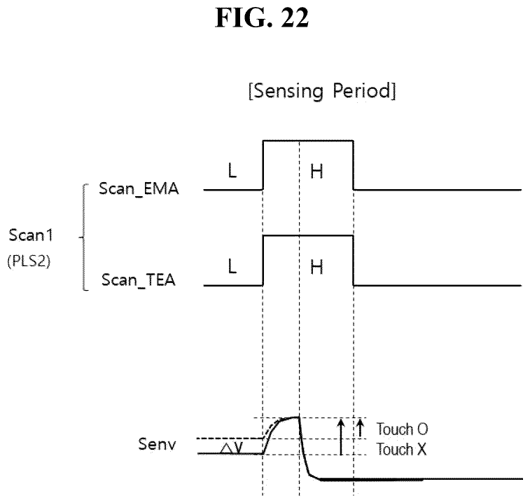

As shown in FIGS. 21 and 22, a period in which a second scan signal Scan2 of a second pulse PLS2 corresponding to a high voltage H is applied can be defined as a sensing period in which the touch drive voltage Driv is sensed.

For the sensing period, the touch drive voltage charged in the first touch area TEA1 is sensed by a touch driver connected to the first touch line THL1 and, as such, can be obtained as a touch sensing voltage Senv. The touch sensing voltage Senv sensed through the first touch line THL1 can be varied in accordance with whether or not the first touch area TEA1 is touched by the user.

For example, when the first touch area TEA1 is touched by the user, the level of the touch sensing voltage Senv can be increased by AV. However, when there is no touch of the first touch area TEA1 by the user, the level of the sensing voltage Senv can be still maintained at the voltage level of the charged state by the touch drive voltage Driv. Accordingly, the touch driver can determine that touch has been generated (Touch O) or touch has not been generated (Touch X), based on a variation in the touch sensing voltage Senv sensed through the first touch line THL1.

As can be seen from FIGS. 16 to 22, the light emitting display device of the second embodiment can be implemented such that the display driving period DSP and the touch driving period TSP are executed while partially overlapping each other, based on two scan signals or the like sequentially generated for one frame 1Frame while having a predetermined generation time difference therebetween.

Accordingly, the light emitting display device according to the second embodiment can perform touch sensing while maintaining the same driving frequency as that of display driving previous thereto (there is no lowering of the driving frequency in accordance with driving of the display driving period DSP and the touch driving period TSP in a partially-overlapped state). The light emitting display device according to the second embodiment can eliminate possibility of generation of a cross talk caused by interference between a data line and a touch line because touch sensing can be performed based on the touch line which is disposed in the same direction as that of the data line while being spaced apart from the data line.

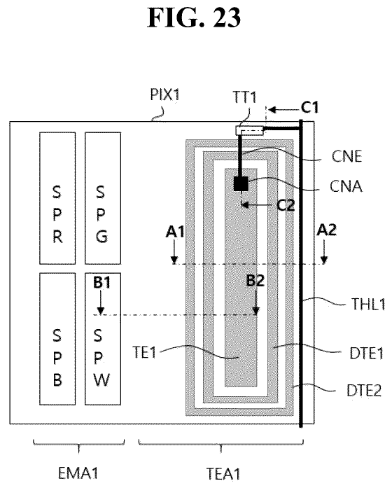

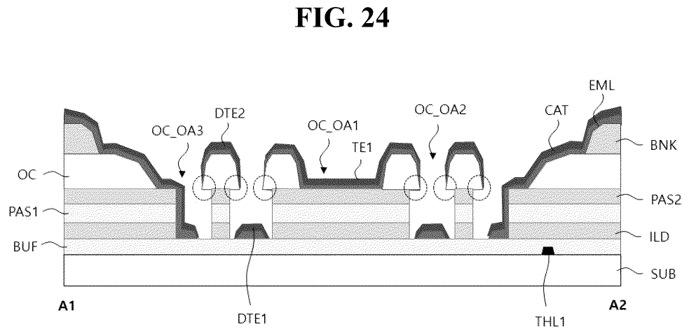

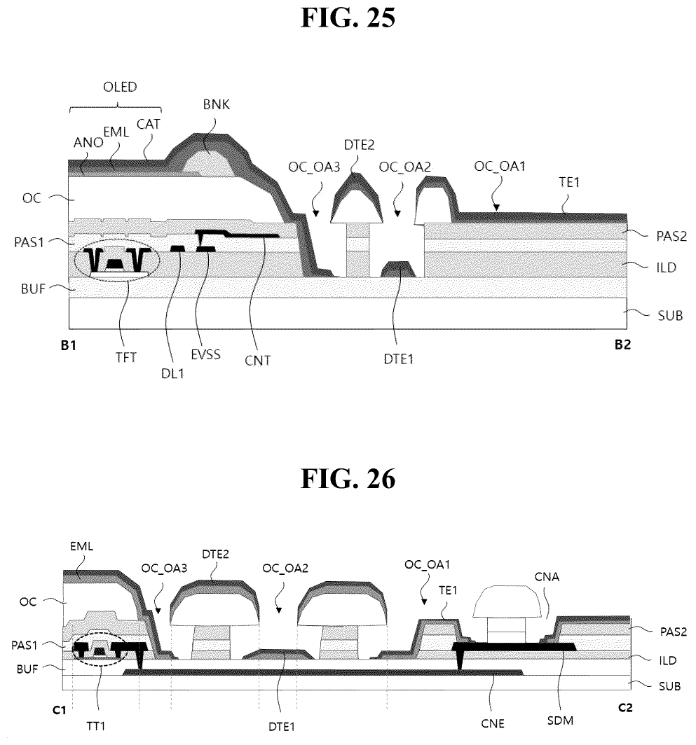

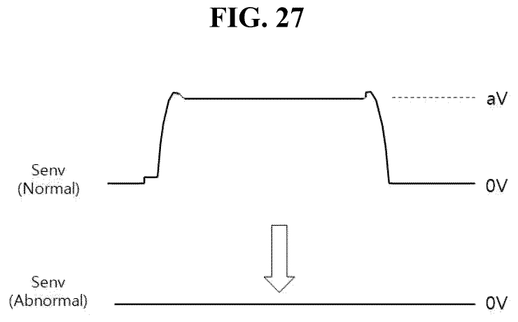

FIG. 23 is a plan view showing a first pixel having a first emissive area and a first touch area in accordance with a third embodiment of the present disclosure. FIG. 24 is a cross-sectional view taken along line A1-A2 of FIG. 23. FIG. 25 is a cross-sectional view taken along line B1-B2 of FIG. 23. FIG. 26 is a cross-sectional view taken along line C1-C2 of FIG. 23. FIG. 27 is a diagram explaining additional characteristics of a light emitting display device including a display panel according to the third embodiment.

As shown in FIG. 23, a first pixel PIX1 can include a first emissive area EMA1 including sub-pixels configured to emit light, and a first touch area TEA1 configured to transmit light (natural light) incident through a front surface or a back surface of the display panel therethrough and to receive a touch input by the user. A first touch electrode TE1 and dummy touch electrodes DTE1 and DTE2 can be disposed in the first touch area TEA1 and can be formed based on a transparent material in order to retain transmission characteristics. The transparent material can be configured in the form of a single layer or multiple layers.

The first emissive area EMA1 can include a red sub-pixel SPR, a green sub-pixel SPG, a blue sub-pixel SPB, and a white sub-pixel SPW. The red sub-pixel SPR and the green sub-pixel SPG can be disposed adjacent to each other at an upper end of the first emissive area EMA1. The blue sub-pixel SPB and the white sub-pixel SPW can be disposed adjacent to each other at a lower end of the first emissive area EMA1. Embodiments are not limited thereto. As an example, the arrangement of the sub-pixels may be variously changed depending on the design.

The first touch area TEA1 can include a first touch transistor TT1, a first touch electrode TE1, dummy touch electrodes DTE1 and DTE2, and a first touch line THL1. The first touch electrode TE1 can be disposed to take the form of a bar (or a rectangle) longer in a vertical direction than in a horizontal direction, without being limited thereto. The dummy touch electrodes DTE1 and DTE2 can be disposed to be spaced apart from the first touch electrode TE1 by a predetermined distance while taking the form of a closed curve surrounding the first touch electrode TE1. Although an example in which two dummy touch electrodes DTE1 and DTE2 are disposed is shown in FIG. 23, disposition of dummy touch electrodes can be varied in accordance with a manufacturing method. As an example, one dummy touch electrode or three or more dummy touch electrodes may be disposed. Alternatively, the dummy touch electrode may be omitted depending on the design.

The first touch transistor TT1 can be disposed at one side of the first touch area TEA1, and can be connected to the first touch line THL1 which is disposed in the vertical direction. The first touch transistor TT1 can be connected to the first touch electrode TE1 through a connection electrode CNE. The connection electrode CNE can be disposed at a layer higher or lower than the first touch electrode TE1 or the dummy touch electrodes DTE1 and DTE2, and can be connected to the first touch electrode TE1 in a connection area CNA.

Meanwhile, although an example in which the first touch transistor TT1 is disposed at an upper end of the first touch area TEA1 is shown in FIG. 23, this is only illustrative, and the first touch transistor TT1 can be disposed at any of an upper side, a lower side, a left side and a right side of the first touch area TEA1. As an example, first touch transistor TT1 can be disposed on the first touch line THL1. In addition, although an example in which four sub-pixels constitute one pixel and one touch area is disposed adjacent thereto is shown in FIG. 23, this can be varied in accordance with the configuration and disposition type of the pixel and the configuration and disposition type of the touch electrodes.

As shown in FIG. 24, the first touch line THL1 can be disposed on a substrate SUB. The first touch line THL1 can be insulated by a buffer layer BUF covering the substrate SUB. An interlayer insulating layer ILD can be disposed on the buffer layer BUF. A first passivation layer PAS1 can be disposed on the interlayer insulating layer ILD. A second passivation layer PAS2 can be disposed on the first passivation layer PAS1. An overcoat layer OC can be disposed on the second passivation layer PAS2. A bank layer BNK can be disposed on the overcoat layer OC. An organic material layer EML can be disposed on the bank layer BNK. The first touch electrode TE1 and the first dummy touch electrode DTE1 as well as a cathode layer CAT can be disposed on the organic material layer EML. As an example, the first touch electrode TE1 and the first dummy touch electrode DTE1 may be formed of the same material as the cathode layer CAT, without being limited thereto.

In accordance with the third embodiment, a first overcoat layer opening OC_OA1, a second overcoat layer opening OC_OA2, and a third overcoat layer opening OC_OA3 can be disposed on the substrate SUB. The first overcoat layer opening OC_OA1, the second overcoat layer opening OC_OA2, and the third overcoat layer opening OC_OA3 can be formed through patterning of the overcoat layer OC in order to provide different structures, respectively.

The first overcoat layer opening OC_OA1 can have an opening configured to expose an upper surface of the second passivation layer PAS2 between portions of the overcoat layer OC respectively disposed at opposite sides thereof. Each of the second overcoat layer opening OC_OA2 and the third overcoat layer opening OC_OA3 can have an opening configured to expose an upper surface of the buffer layer BUF, a side surface of the first passivation layer PAS1, and a side surface of the second passivation layer PAS2 between portions of the overcoat layer OC respectively disposed at opposite sides thereof. Portions of the overcoat layer OC can have an undercut shape by the second overcoat layer opening OC_OA2 and the third overcoat layer opening OC_OA3, respectively, without being limited thereto. As an example, the overcoat layer OC may not have an undercut shape by the second overcoat layer opening OC_OA2 and the third overcoat layer opening OC_OA3.

The organic material layer EML and the first touch electrode TE1 can be disposed within the first overcoat layer opening OC_OA1. The organic material layer EML and the first dummy touch electrode DTE1 can be disposed within the second overcoat layer opening OC_OA2. The organic material layer EML and the cathode layer CAT can be disposed within the third overcoat layer opening OC_OA3. The overcoat layer OC can take the form of a pillar between the second overcoat layer opening OC_OA2 and the third overcoat layer opening OC_OA3. The second dummy touch electrode DTE2 can be disposed on the organic layer EML covering the overcoat layer OC taking the form of a pillar.

As can be seen from an area A1-A2 of FIG. 24, the first touch electrode TE1, the first dummy touch electrode DTE1, the second dummy touch electrode DTE2, and the cathode layer CAT can be electrically isolated from one another by the overcoat layer openings OC_OA1, OC_OA2, and OC_OA3 formed on the substrate SUB.

As shown in FIG. 25, the buffer layer BUF can be disposed on the substrate SUB. The interlayer insulating layer ILD covering a transistor layer TFT can be disposed on the buffer layer BUF. A first data line DL1 and a second power line EVSS can be disposed on the interlayer insulating layer ILD in a state of being spaced apart from each other, without being limited thereto. As an example, the first data line DL1 and the second power line EVSS may be disposed on a different layer. The first passivation layer PAS1 can be disposed on the interlayer insulating layer ILD. A power connection electrode CNT configured to electrically interconnect the second power line EVSS and the cathode layer CAT can be disposed on the first passivation layer PAS1.

The second passivation layer PAS2 can be disposed on the first passivation layer PAS1. The overcoat layer OC can be disposed on the second passivation layer PAS2. An anode layer ANO can be disposed on the overcoat layer OC. The bank layer BNK can be disposed on the overcoat layer OC to cover a portion of the anode electrode ANO. The organic material layer EML can be disposed on the anode layer ANO. The cathode layer CAT can be disposed on the organic material layer EML. Embodiments are not limited thereto. The arrangement of the components and/or layers in the sub-pixel may be variously changed depending on the design.

As can be seen from an area B1-B2 of FIG. 25, the first touch electrode TE1, the first dummy touch electrode DTE1, and the second dummy touch electrode DTE2 can be formed based on the same electrode layer as the cathode electrode CAT which is included in an organic light emitting diode OLED. In accordance with another embodiment of the present disclosure, the first touch electrode TE1, the first dummy touch electrode DTE1, and the second dummy touch electrode DTE2 can be formed based on the same electrode of the anode layer ANO.

Meanwhile, in accordance with a configuration such as an electrode layer, etc. included in the organic light emitting diode OLED, the display panel can emit light in a direction of the cathode layer CAT, a direction of the anode layer ANO, or both directions of the cathode layer CAT and the anode layer ANO.

As can be seen from an area C1-C2 of FIG. 26, the first touch transistor TT1 can be implemented to have the same structure as that of the transistor layer TFT shown in FIG. 25, without being limited thereto. As an example, the first touch transistor TT1 may be implemented to have the same structure as that of the switching transistor of the sub-pixel, without being limited thereto. Of course, this should be interpreted as one example. The first touch transistor TT1 can be connected, at a first electrode thereof, to the first touch electrode TE1 through the connection electrode CNE disposed between the substrate SUB and the buffer layer BUF and through a source/drain layer SDM disposed on the interlayer insulating layer ILD.

As shown in FIGS. 25 to 27, the light emitting display device including the display panel according to the third embodiment can check whether or a short circuit has been generated (short circuit generation position), based on a sensing operation of a touch driver. This will be described hereinafter in conjunction with an example.

The first touch electrode TE1 and the cathode layer CAT can be formed based on the same electrode layer, and can be electrically isolated from each other by the overcoat layer openings OC_OA1, OC_OA2, and OC_OA3. Embodiments are not limited thereto. As an example, the first touch electrode TE1 and the cathode layer CAT may be formed based on the same electrode layer, and may be electrically isolated from each other without the overcoat layer openings OC_OA1, OC_OA2, and OC_OA3. As an example, the first touch electrode TE1 and the cathode layer CAT may be formed based on different electrode layers.

When the first touch electrode TE1 and the cathode layer CAT have a normal structure in which the first touch electrode TE1 and the cathode layer CAT are electrically isolated from each other, a touch sensing voltage Senv detected by a sensing operation of the touch driver can be sensed to be a voltage of a V higher than 0 V or a voltage applied to the second power line EVSS, without being limited thereto.

On the other hand, when the first touch electrode TE1 and the cathode layer CAT have an abnormal structure in which the first touch electrode TE1 and the cathode layer CAT are not electrically isolated from each other (the first touch electrode TE1 and the cathode layer CAT are short-circuited), a touch sensing voltage Senv detected by a sensing operation of the touch driver can be sensed to be 0 V, without being limited thereto. This is because the cathode layer CAT and the second power line EVSS are in a state of being connected to each other and, as such, the touch sensing voltage Senv can also be lowered to 0 V by a voltage applied to the second power line EVSS when the first touch electrode TE1 and the cathode layer CAT are short-circuited. Embodiments are not limited thereto. As an example, the voltage applied to the second power line EVSS may be not 0 V. In this case, when the first touch electrode TE1 and the cathode layer CAT have an abnormal structure in which the first touch electrode TE1 and the cathode layer CAT are not electrically isolated from each other (the first touch electrode TE1 and the cathode layer CAT are short-circuited), a touch sensing voltage Senv detected by a sensing operation of the touch driver may be sensed to be a voltage applied to the second power line EVSS, instead of 0 V.

Accordingly, the light emitting display device including the display panel according to the third embodiment can detect whether or not there is failure of a touch electrode and a failure generation position by itself and, as such, it can be possible to enhance production yield and to omit a separate inspection structure and separate inspection equipment.

As apparent from the above description, the display device according to aspects of the present disclosure has an effect capable of omitting a separate read-out integrated circuit (ROIC) because a touch electrode used as a touch sensor is disposed in a transmissive area, a touch line is disposed in the same direction as that of a data line while being spaced apart from the data line, and the touch electrode is driven in a scan manner. In addition, the display device according to aspects of the present disclosure can have an effect capable of reducing or minimizing the number of touch lines because touch lines are disposed in the same direction as data lines while being spaced apart from the data lines. Furthermore, the display device according to aspects of the present disclosure can have an effect capable of eliminating possibility of generation of a cross talk caused by interference between a data line and a touch line based on spaced dispositions of the data line and the touch line. In addition, the display device according to aspects of the present disclosure can detect whether or not there is failure of a touch electrode and a failure generation position by itself and, as such, can have an effect capable of enhancing production yield and omitting provision of a separate inspection structure and separate inspection equipment.

Effects according to the example embodiments of the disclosure are not limited to the above-illustrated contents, and more various effects can be included in the disclosure.

Although the various embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A display device comprising:
a substrate;
an emissive area defined on the substrate, the emissive area comprising a light emitting element configured to emit light;
a touch area disposed adjacent to the emissive area and configured to sense whether or not there is a touch; and
a gate line connected to the emissive area and the touch area in common.

2. The display device according to claim 1, wherein the gate line is connected in common to a gate of a switching transistor disposed in the emissive area and a gate of a touch transistor disposed in the touch area.

3. The display device according to claim 2, wherein, for one frame, the gate line first transmits a scan signal of a first pulse and then transmits a scan signal of a second pulse after a predetermined time elapses from the transmission of the scan signal of the first pulse.

4. The display device according to claim 3, wherein:
in response to the scan signal of the first pulse, a data voltage is applied to the emissive area through the switching transistor, and a touch drive voltage is applied to the touch area through the touch transistor; and
in response to the scan signal of the second pulse, a touch drive voltage charged in the touch area is sensed as a touch sensing voltage.

5. The display device according to claim 4, wherein the touch sensing voltage is sensed to be a voltage higher than 0 V.

6. The display device according to claim 3, wherein:
the second pulse has the same level as the first pulse, and
the predetermined time between the first pulse and the second pulse is constant for all gate lines of the display device.

7. The display device according to claim 3, wherein:
the second pulse for one gate line overlaps the first pulse for another gate line of the display device.

8. The display device according to claim 1, wherein the touch area further comprises at least one dummy touch electrode disposed as a form of a closed curve surrounding a touch electrode, to be spaced apart from the touch electrode.

9. The display device according to claim 8, wherein the at least one dummy touch electrode includes a first dummy touch electrode and a second dummy touch electrode disposed between the first dummy touch electrode and the touch electrode, and
wherein the second dummy touch electrode is disposed at a different layer than the first dummy touch electrode and the touch electrode, so as to be spaced apart from the first dummy touch electrode and the touch electrode vertically.

10. A display device comprising:
a display panel comprising a pixel and a gate line,
wherein the pixel comprises an emissive area and a touch area disposed adjacent to the emissive area,
wherein the emissive area comprises a light emitting element configured to emit light,
wherein the touch area comprises a touch electrode configured to sense whether or not there is a touch, and
wherein the gate line is connected to the emissive area and the touch area disposed in the pixel in common; a scan driver connected to the gate line; and
a data driver connected to the pixel,
wherein the data driver comprises a first circuit configured to supply a data voltage to the emissive area, and a second circuit configured to supply a touch drive voltage to the touch area.

11. The display device according to claim 10, wherein, for one frame, the scan driver first outputs a scan signal of a first pulse and then outputs a scan signal of a second pulse through the gate line after a predetermined time elapses from the output of the scan signal of the first pulse.

12. The display device according to claim 11, wherein:
the data driver outputs a data voltage through a data line connected to the emissive area, and outputs a touch drive voltage through a touch line connected to the touch area, in response to the scan signal of the first pulse; and
the data driver senses a touch drive voltage charged in the touch area as a touch sensing voltage in response to the scan signal of the second pulse.

13. The display device according to claim 12, wherein the gate line is connected to a gate of a switching transistor disposed in the emissive area and a gate of a touch transistor disposed in the touch area in common.

14. The display device according to claim 13, wherein:
the scan driver is controlled so that the scan signal of the first pulse and the scan signal of the second pulse are sequentially applied to all gate lines of the display panel; and
the data driver is controlled to sense the touch sensing voltage from all pixels of the display panel, corresponding to the sequential application of the scan signals.

15. The display device according to claim 13, wherein:
the emissive area comprises a red sub-pixel, a green sub-pixel, a blue sub-pixel, and a white sub-pixel; and
the touch area comprises at least one dummy touch electrode surrounding the touch electrode.

16. The display device according to claim 15, wherein the touch transistor is connected to the gate line at the gate thereof, while being connected to the touch line at a first electrode thereof and connected to the touch electrode at a second electrode.

17. The display device according to claim 16, wherein the second electrode of the touch transistor is connected to the touch electrode through a connection electrode disposed at a layer higher or lower than the at least one dummy touch electrode.

18. The display device according to claim 10, wherein the touch area comprises a transmission area configured to transmit natural light or an object incident thereto through a front surface or a back surface of the display panel.

19. A driving method of a display device comprising a display panel including an emissive area defined on a substrate, a touch area disposed adjacent to the emissive area, and a gate line, the emissive area including a light emitting element configured to emit light, the touch area being configured to sense whether or not there is a touch, and the gate line being connected to the emissive area and the touch area in common, the driving method comprising:
outputting a scan signal of a first pulse for one frame through the gate line; and
outputting a scan signal of a second pulse for the one frame through the gate line,
wherein the scan signal of the second pulse is output after a predetermined time has elapsed from the outputting of the scan signal of the first pulse.
